(19) United States
(12) Patent Application Publication
(10) Pub. No.: US 2011/0225055 A1
(43) Pub. Date: Sep. 15, 2011

(54) CHECKOUT APPARATUS AND CHECKOUT PROCESSING METHOD

(75) Inventor: Nobuyuki Takahashi, Shizuoka (JP)

(73) Assignee: TOSHIBA TEC KABUSHIKI KAISHA, Tokyo (JP)

(21) Appl. No.: 13/036,388

(22) Filed: Feb. 28, 2011

(30) Foreign Application Priority Data
Mar. 12, 2010 (JP) 2010-056434

(51) Int. Cl. G06Q 30/00

(52) U.S. Cl. 705/16

(57) ABSTRACT

According to one embodiment, a checkout processing apparatus includes an operator unit, a rotation mechanism, a determination unit, and a switching unit. The operator unit executes checkout processing. The rotation mechanism rotatably supports the operator unit and stops the operator unit at least at two positions. The determination unit determines which of the positions the operator unit is stopped at. The switching unit switches a function of the checkout processing according to a result of the determination by the determination unit.

### CROSS-REFERENCE TO RELATED APPLICATIONS

This application is based upon and claims the benefit of priority from Japanese Patent Application No. 2010-056434, filed on Mar. 12, 2010, the entire contents of which are incorporated herein by reference.

### FIELD

Embodiments described herein relate generally to a checkout apparatus capable of input of information about an article purchased by a customer and settlement of a commercial transaction with the customer, and a checkout processing method for this apparatus.

### BACKGROUND

A checkout apparatus is capable of input of information about an article purchased by a customer and settlement of a commercial transaction with the customer.

Such checkout apparatus is usually operated by a cashier who is in charge of this operation in a store. Recently, a self-service checkout apparatus improved to enable a customer to operate is also put into practice use.

### BRIEF DESCRIPTION OF THE DRAWINGS

FIG. 1 shows the appearance of an embodiment of a checkout apparatus.

FIG. 2 is an exploded view showing a configuration of the apparatus.

FIG. 3 is a block diagram showing a main configuration of a control processing unit in the apparatus.

FIG. 4 is a flowchart showing procedures for mode switching executed according to a control program installed in the apparatus.

FIG. 5 shows an exemplary checkout processing screen in a cashier mode in the apparatus.

FIG. 6 shows an exemplary checkout processing screen in a self-service mode in the apparatus.

FIG. 7 shows an exemplary checkout processing screen in the self-service mode in the apparatus.

FIG. 8 shows an exemplary checkout processing screen in the self-service mode in the apparatus.

FIG. 9 shows an exemplary checkout processing screen in the self-service mode in the apparatus.

### DETAILED DESCRIPTION

In general, according to one embodiment, a checkout processing apparatus includes an operator unit, a rotation mechanism, a determination unit, and a switching unit. The operator unit executes checkout processing. The rotation mechanism rotatably supports the operator unit and stops the operator unit at least at two positions. The determination unit determines which of the positions the operator unit is stopped at. The switching unit switches a function of the checkout processing according to a result of the determination by the determination unit.

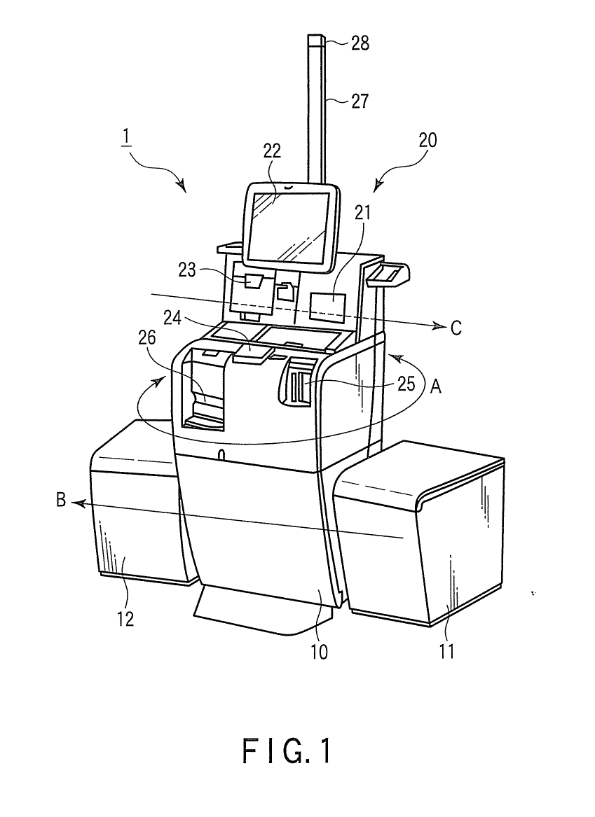

FIG. 1 shows the appearance of a checkout apparatus 1. The checkout apparatus 1, as a stand-alone unit, functions as an electronic cash register. The check apparatus 1 constructs a POS system when the apparatus 1 is connected to a POS (point of sales) server.

The apparatus 1 can switch between checkout processing in a cashier mode and checkout processing in a self-service mode.

The checkout processing includes processing to acquire article information such as article name and unit price according to an input of an article code that identifies an article, processing to register sales data to a memory based on the article information and calculate a total amount of money in a commercial transaction, processing to settle the commercial transaction based on the total amount of money and price data when the price data is inputted, and processing to issue a receipt on which the content of the settled commercial transaction is recorded.

Such checkout processing is executed by the cashier's operation when the processing is in the cashier mode, and executed by the customer's operation when the processing is in the self-service mode.

The apparatus 1 includes an operator unit 20 and a body base unit 10. The operator unit 20 is attached to a top part of the body base unit 10, rotatably in the direction of arrow A. FIG. 1 shows the direction in which the operator unit 20 is arranged in the self-service mode. There is a shopping basket placing table 11 and an article bagging table 12 on each side of the body base unit 10. The shopping basket placing table 11 and the article bagging table 12 are arranged along a direction of article flow B in the cashier mode and a direction of article flow C in the self-service mode.

The operator unit 20 includes a scanner 21, a display 22, a receipt printer 23, a coin insertion unit 24, a banknote insertion and discharge unit 25, a change discharge unit 26, and a notification lamp 28 on a pole 27.

The scanner 21 fixed on the operator unit 20 reads a data code such as a barcode attached to an article.

The display 22 displays the article name, unit price, number of items and so on corresponding to the data code read by the scanner 21. The display 22 also displays the total amount of money of all the articles sold in one commercial transaction, the amount of change and so on. The receipt printer 23 issues a receipt on which the details of one commercial transaction are printed.

At the coin insertion unit 24, coins of cash paid for the total amount of money are inserted by the cashier or the customer. At the banknote insertion and discharge unit 25, similarly banknotes of cash are inserted by the cashier or the customer and banknotes of change are discharged. At the change discharge unit 26, coins of change are discharged. The notification lamp 28 turns on while the apparatus 1 is executing the checkout processing.

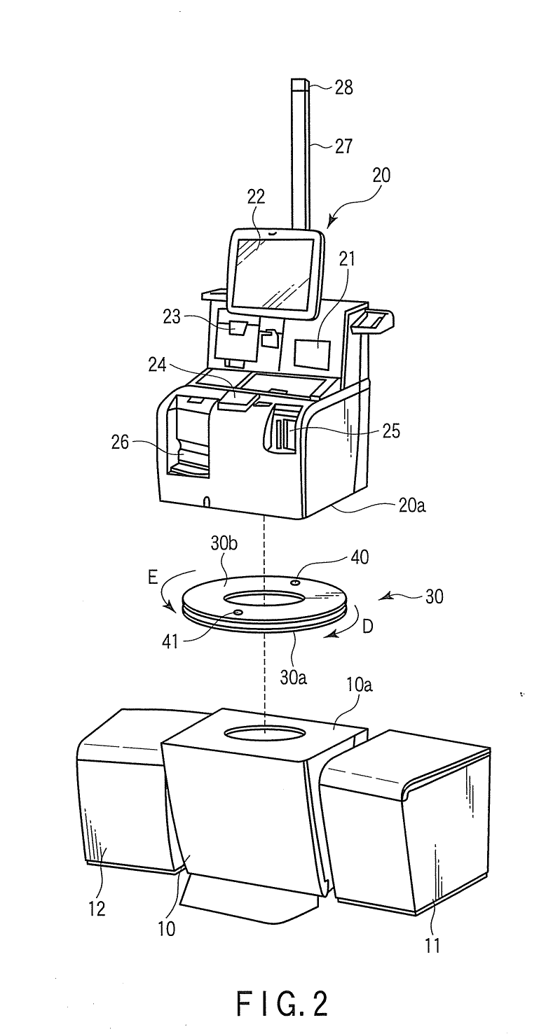

There is a pair of turntables 30 as a rotation mechanism between the body base unit 10 and the operator unit 20, as shown in the exploded configuration view of FIG. 2. The turntables 30 support the operator unit 20 on the body base unit 10 rotatably in the direction of arrow A. The turntables 30 enable the operator unit 20 to stop at least at two positions on the body base unit 10.

The two positions are the position in the self-service mode, for example, shown in FIG. 1, and the position in the cashier mode, reached by rotating the operator unit 20 by 180 degrees from the above position. The scanner 21, the display 22, the receipt printer 23, the coin insertion unit 24, the banknote insertion and discharge unit 25 and the change discharge unit 26 face the cashier when the operator unit 20 is at the position in the cashier mode. These units face the customer who carries out payment when the operator unit 20 is at the position in the self-service mode.

The turntables 30 include a base-side turntable 30a and a unit-side turntable 30b. The base-side turntable 30a is fixed to a top surface 10a of the body base unit 10. The unit-side turntable 30b is fixed to a bottom surface 20a of the operator unit 20. The unit-side turntable 30b is rotatable in the direction indicated by arrow D or arrow E relatively to the base-side turntable 30a.

Position sensors 40 and 41 are provided on the base-side turntable 30a and the unit-side turntable 30b. The position sensors 40 and 41 output a position signal when the operator unit 20 is at the position in the self-service mode and when the operator unit 20 is at the position in the cashier mode.

In this embodiment, an optical sensor including a light emitting element and s light receiving element is used as the position sensors 40 and 41. The position sensor 40 includes a light emitting element and a light receiving element. The position sensor 41 includes a light receiving element.

The light emitting element of the position sensor 40 is fixed at one position on the surface of the base-side turntable 30a that faces the unit-side turntable 30b. The light receiving element of the position sensor 40 and the light receiving element of the position sensor 41 are fixed at two positions on a diagonal line on the surface of the unit-side turntable 30b that faces the base-side turntable 30a.

The light receiving element of the position sensor 40 receives emitted light from the light emitting element when the operator unit 20 is at the position in the cashier mode. The light receiving element of the position sensor 41 receives emitted light from the light emitting element when the operator unit 20 is at the position in the self-service mode. Each light receiving element outputs a position signal as the light receiving element receives light.

Therefore, when a position signal is outputted from the light receiving element of the position sensor 40, the operator unit 20 is at the position in the cashier mode. When a position signal is outputted from the light receiving element of the position sensor 41, the operator unit 20 is at the position in the self-service mode.

The position sensors 40 and 41 are not limited to the above configuration. For example, the light emitting element of the position sensor 40 may be fixed on the base-side turntable 30a and the light receiving element of the position sensor 40 and the light receiving element of the position sensor 41 may be fixed on the unit-side turntable 30b. Alternatively, a mechanical switch including a switch body and an operator which switches on and off the switch body may be used.

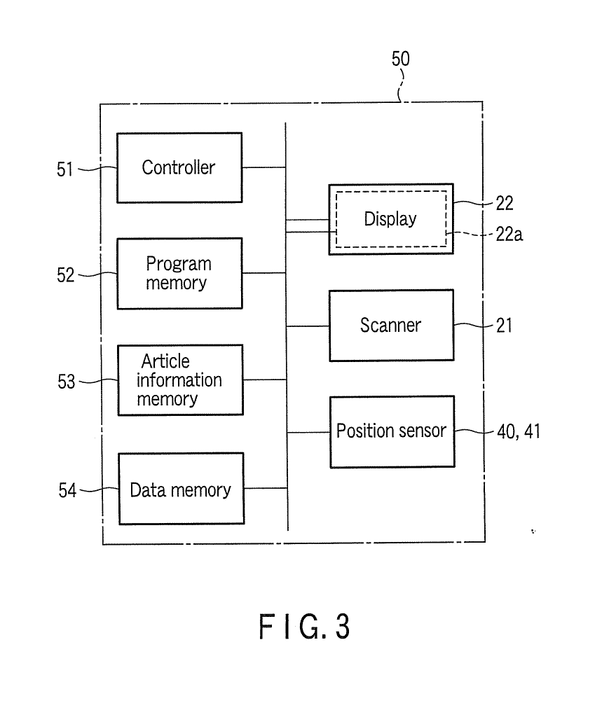

FIG. 3 is a block diagram showing a main configuration of a control processing unit 50 in the apparatus 1. The control processing unit 50 has a controller 51 having a CPU (central processing unit) as its principal component. In the control processing unit 50, a program memory 52, an article information memory 53, a data memory 54, the scanner 21, the display 22, and the position sensors 40 and 41 are connected to the controller 51.

The display 22 has a touch panel 22a arranged on its screen. The touch panel 22a detects a touch operation on the screen by the cashier or the customer and outputs a position signal corresponding to the touched part to the controller 51.

The program memory 52 stores an application program to cause the controller 51 to realize the checkout processing in the cashier mode and an application program to cause the controller 51 to realize the checkout processing in the self-service mode. The program memory 52 also stores a control program to cause the controller 51 to realize the switching between the function of the checkout processing in the cashier mode and the function of the checkout processing in the self-service mode.

The article information memory 53 stores article information including name, unit price, discount rate and the like of various articles in advance. The data memory 54 stores a recognition number to permit the mode switching. The recognition number is a unique ID number that is preset for a clerk authorized to switch modes. For example, each clerk holds a name tag on which a barcode indicating his or her ID number is printed. The clerk inputs his or her ID number to the apparatus 1 by having this barcode read by the scanner 21.

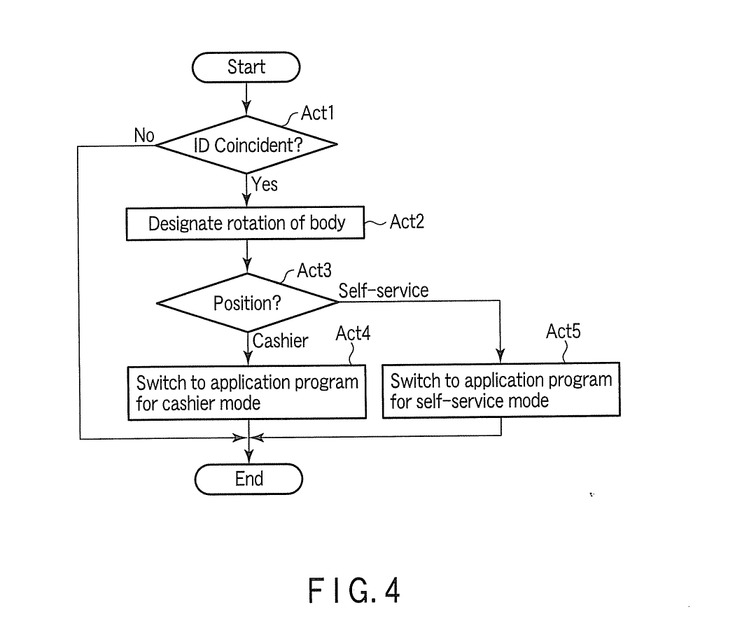

As the ID number is inputted, the control program starts. When the control program is started, the controller 51 executes mode switching according to the procedures shown in the flowchart of FIG. 4.

First, the controller 51 determines whether or not the inputted ID number coincides with an ID number stored in the data memory 53 (ACT 1). When the ID numbers are not coincident, this control program ends.

When the ID numbers are coincident, the controller 51 displays guidance “Rotate the body” on the display 22 (ACT 2). The controller 51 then waits for the output source of the position signal to change (ACT 3). When the operator unit 20 moves from the position in the self-service mode to the position in the cashier mode, the output source of the position signal changes from the position sensor 41 to the position sensor 40. When the operator unit 20 moves from the position in the cashier mode to the position in the self-service mode, the output source of the position signal changes from the position sensor 40 to the position sensor 41.

When the output source of the position signal changes from the position sensor 41 to the position sensor 40, the controller 51 switches the application program for the checkout processing from the program supporting the self-service mode to the program supporting the cashier mode (ACT 4).

When the output source of the position signal changes from the position sensor 40 to the position sensor 41, the controller 51 switches the application program for the checkout processing from the program supporting the cashier mode to the program supporting the self-service mode (ACT 5). Then, this control program ends.

Therefore, only the clerk whose ID number is registered in the data memory 54 can carry out the switching between the cashier mode and the self-service mode. As this clerk has his or her ID number read by the scanner 21, guidance “Rotate the body” is displayed on the display 22. After confirming the guidance, the clerk rotates the operator unit 20 by 180 degrees.

Then, if the processing is in the cashier mode before the rotation, the mode is switched to the self-service mode after the rotation. Then, the application program for the controller 51 to realize the checkout processing in the self-service mode starts.

Meanwhile, if the processing is in the self-service mode before the rotation, the mode is switched to the cashier mode after the rotation. Then, the application program for the controller 51 to realize the checkout processing in the cashier mode starts.

Therefore, no operations are necessary to change the application programs to realize the function of each checkout processing when switching between the cashier mode and the self-service mode.

A clerk whose ID number is not registered in the data memory 54 cannot carry out switching between the cashier mode and the self-service mode. If the operator rotates the operator unit 20 before an ID number is inputted, a warning “Have your ID card read” is displayed on the display 22.

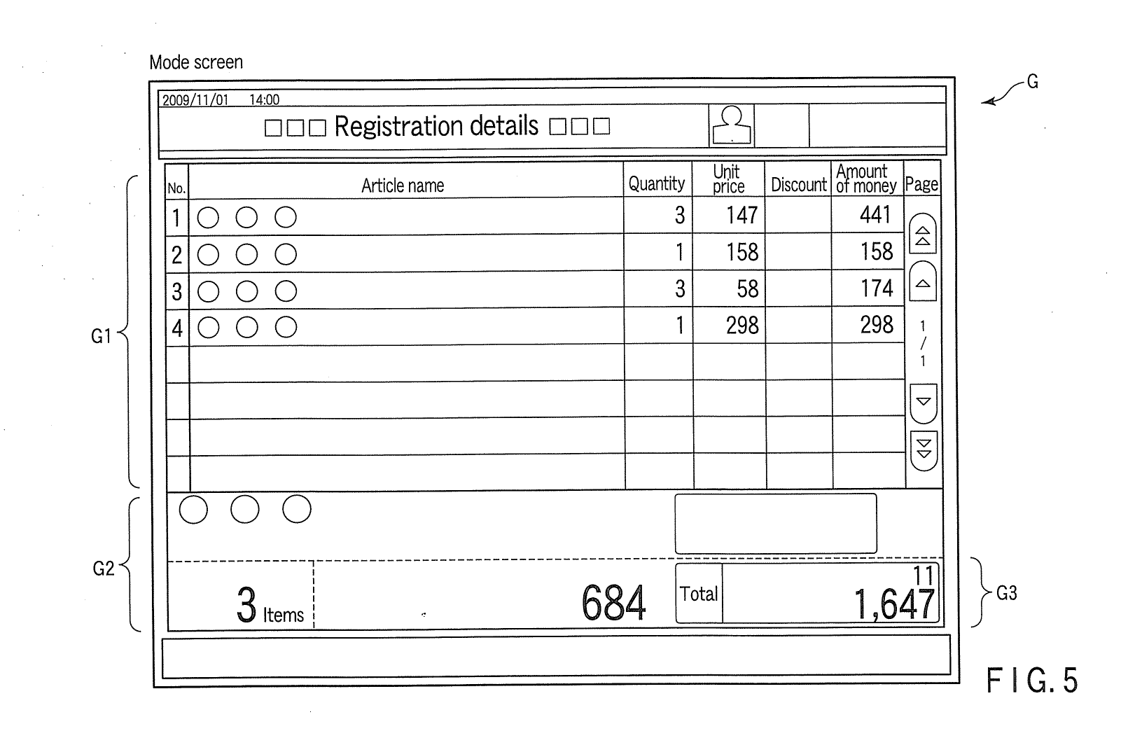

When the application program for the checkout processing is the program supporting the cashier mode, the controller 51 displays a checkout processing screen G having a layout as shown in FIG. 5 on the display 22.

The checkout processing screen G is divided into a first section G1 where article information including article name, quantity, unit price, amount of money and the like is displayed in the form of a list, a second section G2 where the article name, quantity and amount of money of a single article are displayed, and a third section G3 where the total number of items and the total amount of money are displayed.

When the barcode on the first item of the articles purchased by the customer is read by the scanner, the article name, quantity and amount of money of the article are displayed in the second section. Then, when the barcode on the second item is read by the scanner, the article name, quantity and amount of money of the first item are displayed in the first line in the first section G1 and the article name, quantity and amount of money of the second item are displayed in the second section G2. The total number of items and the total amount of money of the first and second items are displayed in the third section G3.

When the barcode on the third item is read by the scanner, the article name, quantity and amount of money of the second item are displayed in the second line in the first section G1 and the article name, quantity and amount of money of the third item are displayed in the second section G2. The total number of items and the total amount of money of the first to third items are displayed in the third section G3. Subsequently, what is displayed in the first, second and third sections G1, G2 and G3 is updated as described above every time the barcode on an article is read by the scanner.

When the processing is in the cashier mode, the scanner 21, the display 22, the receipt printer 23, the coin insertion unit 24, the banknote insertion and discharge unit 25 and the change discharge unit 26 face the cashier. Therefore, the cashier can quickly input information of articles purchased by the customer to the apparatus 1 by using the scanner 21. The cashier can also receive and give money quickly for the customer's payment.

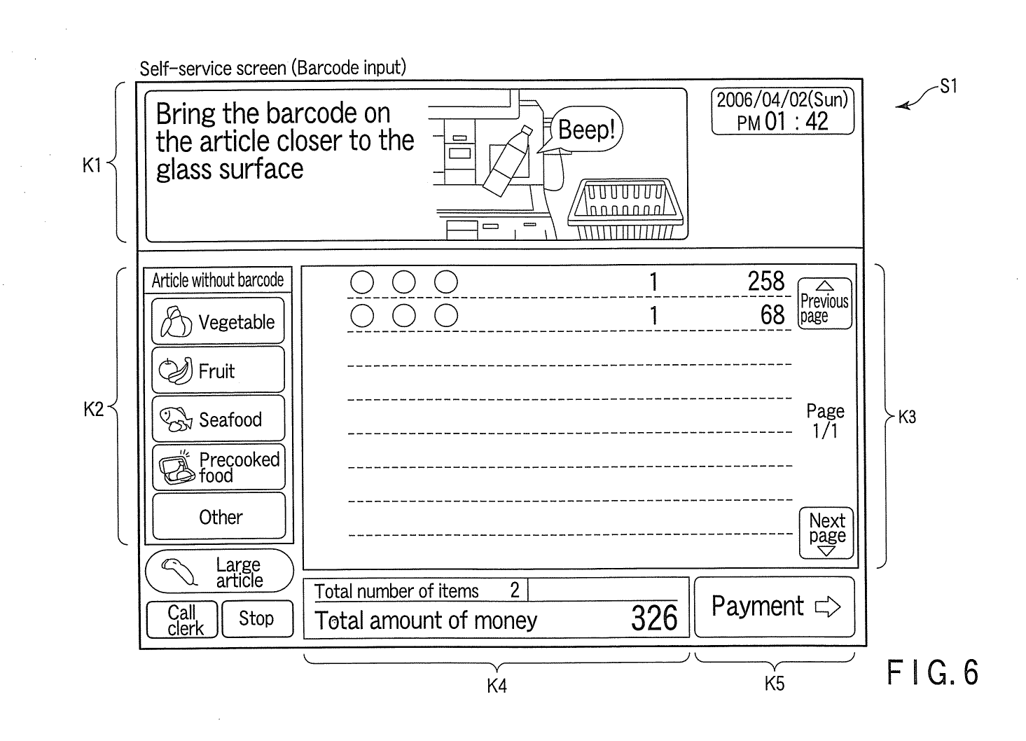

When the application program for the checkout processing is switched to the program supporting the self-service mode, the controller 51 displays a checkout processing screen S1 having a layout as shown in FIG. 6, on the display 22.

The checkout processing screen S1 is divided into a guidance section K1, an article selection section K2, a detail section K3, a total section K4, and a payment button K5. In the guidance section K1, guidance for the customer who operates the apparatus 1, for example, “Bring the barcode on the article closer to the glass surface” and a picture to this effect are displayed. In the article selection section K2, buttons for selecting categories to which articles without barcode belong are displayed. In the detail section K3, the article names, quantities and unit prices of plural articles are displayed. In the total section K4, the total number of items and the total amount of money are displayed.

When the mode is changed to the self-service mode, the scanner 21, the display 22, the receipt printer 23, the coin insertion unit 24, the banknote insertion and discharge unit 25 and the change discharge unit 26 face the customer who carries out payment. Thus, after confirming the guidance on the checkout processing screen S1, the customer brings the barcode on the article which the customer purchases closer to the glass surface of the scanner 21. When the barcode is consequently read by the scanner 21, the article name, quantity and amount of money of the article are displayed in the first line in the detail section K3.

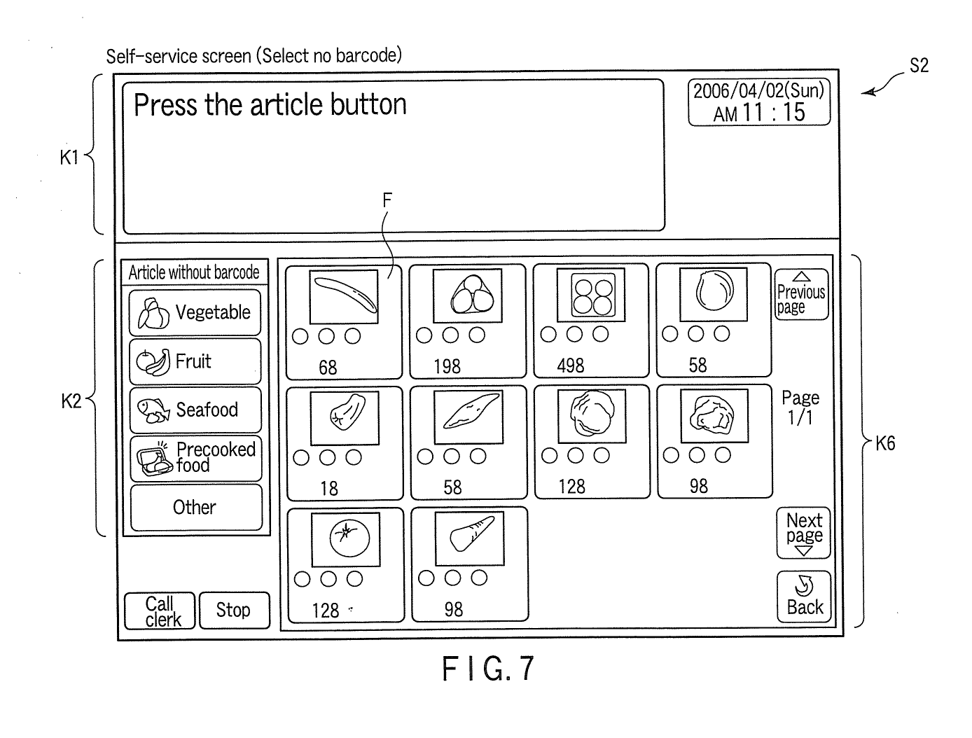

When no barcode is attached to an article, the customer selects a button indicating the category of that article in the article selection section K2 and touches the button. Then, the screen changes to a checkout processing screen S2, for example, as shown in FIG. 7. The screen S2 is the checkout processing screen which appears when the category button “Vegetable” in the article selection section K2 is touched.

The checkout processing screen S2 is divided into a guidance section K1, an article selection section K2, and an item selection section K6. In the guidance section K1, guidance to the customer at this point “Press the article button” is displayed. In the item selection section K6, a button group F for articles without barcode, of article items belonging to the category “Vegetable”, is displayed. On each button F, the photograph, article name and unit price of the article are displayed.

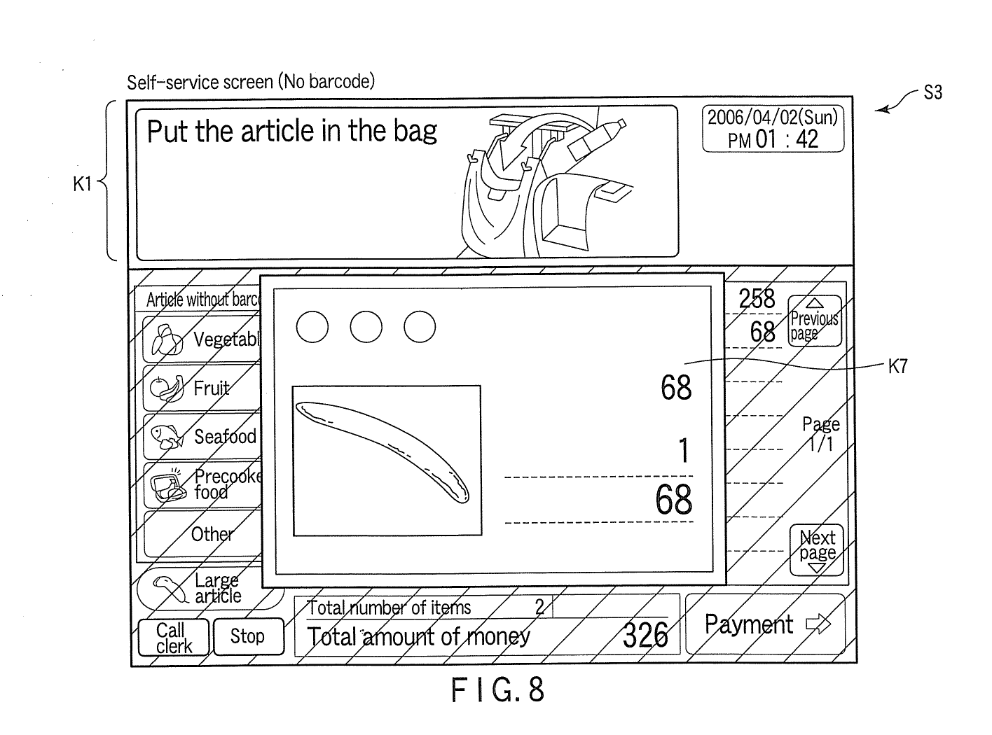

The customer touches the button F of the corresponding article item. Then, the screen changes to a checkout processing screen S3, for example, as shown in FIG. 8. The screen S3 is the checkout processing screen S3 which appears when the button F of the article item “Cucumber” is touched.

The checkout processing screen S3 shows a guidance section K1 and an item confirmation section K7. In the guidance section K1, guidance for the customer at this point “Put the article in the bag” and a picture to this effect are displayed. In the item confirmation section K7, the photograph, article name and unit price of the article item “Cucumber” selected by the touch on the button F are displayed in an enlarged view.

When the article is put in the bag, the screen returns to the checkout processing screen S1 shown in FIG. 6. Therefore, the customer can easily input information of articles which the customer purchases to the apparatus 1 by using the scanner 21 or the display 22.

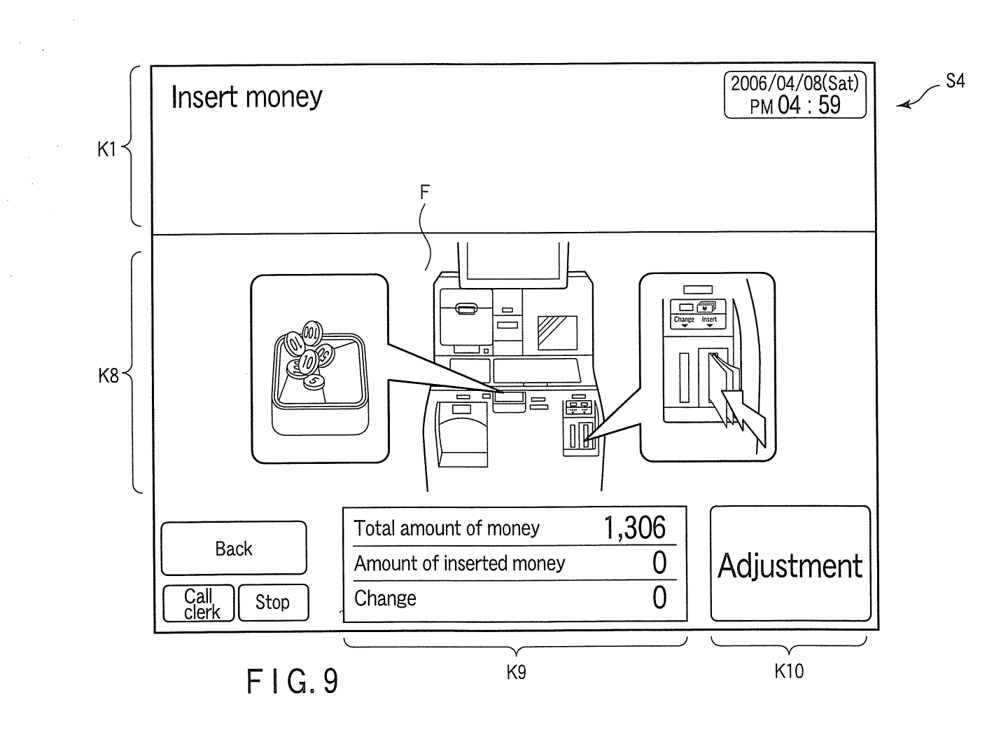

When the input of all the information of the articles purchased by the customer is finished, the customer touches the payment button section K5. Then, the screen changes to a checkout processing screen S4 as shown in FIG. 9. The screen S4 is divided into a first guidance section K1, a second guidance section K8, a total amount section K9 and an adjustment button K10. In the first guidance section K1, guidance for the customer at this point “Insert money” is displayed. In the second guidance section K8, guidance showing a picture explaining how to pay is displayed.

The customer inserts money to the coin insertion unit 24 and the banknote insertion and discharge unit 25 according to the guidance, and touches the adjustment button K10. The commercial transaction can thus be settled.

In this manner, the checkout processing screens S1 to S4 in the self-service mode show contents including more detailed guidance than in the checkout processing screen G in the cashier mode. Therefore, children, the old or the customers who operate the apparatus for the first time can operate the apparatus with ease.

Other embodiments will be described hereinafter.

In the apparatus 1 in the above embodiment, the operation guidance for the customer is displayed in the guidance section K1 in the checkout processing screens S1 to S4 when the processing is in the self-service mode. In an apparatus according to another embodiment, the content of the guidance displayed in the guidance section K1 is notified of via audio output.

In the apparatus 1 in the above embodiment, in the switching between the functions of the cashier mode and the self-service mode, the independent programs, that is, the application program supporting the cashier mode and the application program supporting the self-service mode, are switched. In an apparatus according to another embodiment, the application program operating in the background is the same and the display content on the display 22 is changed between the cashier mode and the self-service mode. That is, an operation form that is different from the cashier mode is defined as the switch of functions so that, for example, in the self-service mode, guidance is displayed on the display and an operation by the user that is not done as instructed by the display content becomes an error.

The application program supporting the self-service mode can be produced by adding the processing in the checkout processing screens S1 to S4 to the application program supporting the cashier mode. Thus, in an apparatus according to another embodiment, when the processing is in the self-service mode, the application program supporting the self-service mode is executed. When the processing is in the cashier mode, only the necessary part for the cashier mode is extracted from the application program supporting self-service mode and is executed. Thus, in the apparatus according to this another embodiment, it suffices to store only the application program supporting the self-service mode. Therefore, storage capacity can be saved.

In the apparatus 1 in the above embodiment, the position in the cashier mode and the position in the self-service mode are different by 180 degrees. The position where the operator unit 20 stops is not limited to the above two positions. The operator unit 20 may also be configured to stop at plural positions with other rotation angles.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout processing apparatus comprising:
an operator unit which executes checkout processing;
a rotation mechanism which rotatably supports the operator unit and stops the operator unit at least at two positions;
a determination unit which determines which of the positions the operator unit is stopped at; and
a switching unit which switches a function of the checkout processing according to a result of the determination by the determination unit.

2. The apparatus of claim 1, wherein the rotation mechanism can stop at least at an operation position for a cashier and an operation position for a customer, and
the switching unit switches to a checkout processing function in a cashier mode when it is determined that the operator unit is stopped at the operation position for the cashier, and the switching unit switches to a checkout processing function in a self-service mode when it is determined that the operator unit is stopped at the operation position for the customer.

3. The apparatus of claim 2, wherein the operator unit has a display unit on which to display a screen showing a processing content of checkout processing, and
the switching unit displays, on the display unit, a screen corresponding to the checkout processing in the cashier mode when it is determined that the operator unit is stopped at the operation position for the cashier, and the switching unit displays, on the display unit, a screen corresponding to the checkout processing in the self-service mode when it is determined that the operator unit is stopped at the operation position for the customer.

4. The apparatus of claim 2, wherein the switching unit switches to an application program for realizing the checkout processing in the cashier mode when it is determined that the operator unit is stopped at the operation position for the cashier, and the switching unit switches to an application program for realizing the checkout processing in the self-service mode when it is determined that the operator unit is stopped at the operation position for the customer.

5. The apparatus of claim 1, further comprising a storage unit which stores a manager identification number,
wherein the switching unit switches the function of the checkout processing when an externally inputted identification number coincides with the manager identification number stored in the storage unit.

6. The apparatus of claim 5, wherein the switching unit issues a warning when which of the positions the operator unit is stopped at is determined by the determination unit before an identification number is inputted externally.

7. A checkout processing method for a checkout processing apparatus in which an operator unit which executes checkout processing is rotatably supported so that the operator unit stops at least at two positions, the method comprising:
determining which of the positions the operator unit is stopped at; and
switching a function of the checkout processing according to a result of the determination.

8. The method of claim 7, wherein the operator unit can stop at least at an operation position for a cashier and an operation position for a customer, and
the method includes switching to a checkout processing function in a cashier mode when it is determined that the operator unit is stopped at the operation position for the cashier, and switching to a checkout processing function in a self-service mode when it is determined that the operator unit is stopped at the operation position for the customer.

9. The method of claim 8, wherein the operator unit has a display unit on which to display a screen showing a processing content of checkout processing, and
the method includes displaying, on the display unit, a screen corresponding to the checkout processing in the cashier mode when it is determined that the operator unit is stopped at the operation position for the cashier, and displaying, on the display unit, a screen corresponding to the checkout processing in the self-service mode when it is determined that the operator unit is stopped at the operation position for the customer.

10. A non-transitory computer-readable medium storing a program which causes a computer of a checkout processing apparatus in which an operator unit which executes checkout processing is rotatably supported so that the operator unit stops at least at two positions, to carry out the following process routine comprising:
determining which of the positions the operator unit is stopped at; and
switching a function of the checkout processing according to a result of the determination.
